(19) United States
(12) Patent Application Publication
(10) Pub. No.: US 2017/0182535 A1
(43) Pub. Date: Jun. 29, 2017

(54) Roll for High Temperature Environments

(71) Applicant: Extreme Caster Services, Inc., West Middlesex, PA (US)

(72) Inventors: Frank Karns, Fairview, PA (US); Bryan David Votaw, Salem, OH (US)

(73) Assignee: Extreme Caster Services, Inc., West Middlesex, PA (US)

(21) Appl. No.: 15/394,675

(22) Filed: Dec. 29, 2016

Related U.S. Application Data
(60) Provisional application No. 62/272,295, filed on Dec. 29, 2015.

(51) Int. Cl. B21B 27/08; B22D 11/06; F16C 13/02; B21B 27/06

(52) U.S. Cl. CPC B21B 27/08; B21B 27/06; B22D 11/0651; F16C 13/02

(57) ABSTRACT

A roll for continuous casting comprises a cylindrical roll rotatably mounted on a fixed axle and having a cooling chamber that surrounds the axle for receiving a flow of coolant. The axle is mounted on a roll support system. The roll support system comprises a first roll support connected to a coolant supply system and a second roll support connected to a coolant drain system. The axle comprises a first inlet connected to the first roll support, a first outlet connected to the coolant chamber, a second inlet connected to the coolant chamber, and a second outlet connected to the second roll support. A coolant flow circuit has a flow path from the coolant supply system to the coolant drain system through the first roll support, the first inlet, the first outlet, the coolant chamber, the second inlet, the second outlet, and the second roll support.

### BACKGROUND

In continuous casting installations for casting metal strands, rolls are used to guide the metal strand along a predetermined path after leaving the mold and to cool it and possibly support it. The rolls comprise rotatably mounted cylindrical rolls that are free rolling on a fixed axle. The cylindrical rolls rotate as the metal strands move over them. As these rolls are exposed to high temperatures in operation by being in direct contact with the glowing hot metal strands, cooling of the rolls is a high priority. This is typically conducted in a closed circuit by a feed of a coolant (in particular water) under pressure into the interior of the roll to dissipate the heat. Prior art systems typically have included complicated pressure control systems and sealing units that are prone to failure and require significant efforts for maintenance and repair. What is presented is a roll for high temperature environments that has an improved coolant circuit system that addresses some of the drawbacks of prior art systems.

### SUMMARY

A roll for continuous casting is presented that comprises a cylindrical roll rotatably mounted on a fixed axle and having a cooling chamber for receiving a flow of coolant. The coolant chamber surrounds the axle. The axle is mounted on a roll support system and comprising a coolant inlet system, a barrel, and a coolant outlet system. The roll support system further comprises a first roll support connected to a coolant supply system and a second roll support connected to a coolant drain system. The coolant inlet system comprises a first inlet connected to the first roll support and a first outlet connected to the coolant chamber. The coolant outlet system comprises a second inlet connected to the coolant chamber and a second outlet connected to the second roll support. A coolant flow circuit has a flow path from the coolant supply system to the coolant drain system through the first roll support, the first inlet and said first outlet of said coolant inlet system, said coolant chamber, said second inlet and said second outlet of said coolant outlet system, and said second roll support.

The coolant in such rolls may be any appropriate for the particular application but it is typically water. The coolant is supplied from the coolant supply system under pressure which is preferably at 30 psi. The coolant supply system provides a continuous flow of coolant to the coolant flow circuit while the roll is in operation. The cylindrical roll is supported on the axle with sealed bearings. The roll may further comprise sleeves interposed on the axle between the cylindrical roll and each of the first roll support and the second roll support.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a perspective view of a roll that incorporates the disclosed improvements;

FIG. 2 is a cross-sectional view of the roll of FIG. 1 along the lines indicated in FIG. 1;

FIG. 3 is a cross-sectional view of the roll of FIG. 1 along the lines indicated in FIG. 2;

FIG. 4A is a view of the axle of the roll of FIG. 1; and

FIG. 4b is a cross-sectional view of the axle of FIG. 4A along the lines indicated in FIG. 4A.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

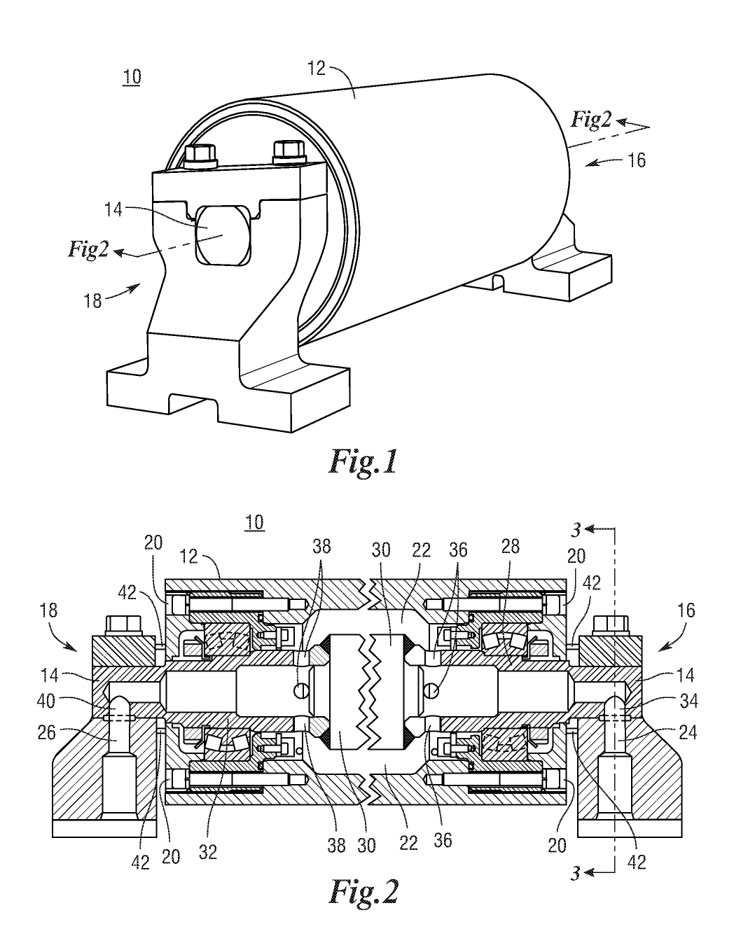

FIG. 1 shows a perspective view of a roll 10 for continuous casting of metal strands. Rolls 10 such as these act as guides in continuous casting applications to direct extremely hot metal strands as they cool. A plurality of such rolls 10 are arranged in sequence to support and guide metal strands along the casting facility. Each roll 10 comprises a cylindrical roll 12 rotatably mounted on a fixed axle 14 such that the cylindrical roll 12 rotates when metal strands move over the roll 10 while the axle 14 remains fixed. The axle 14 is mounted on a roll support system that comprises a first roll support 16 and a second roll support 18. Some rolls 10 are arranged in a horizontal path to direct the metal stands on top of them. Such horizontally oriented rolls 10 bear the weight and the heat of the metal strands as they move over them. Some rolls 10 are arranged vertically to direct and maintain the metal strands on top of the horizontally oriented rolls 10. Because each roll 10 comes in direct contact with the metal strands, heat transfer and cooling of each roll 10 is essential. It has been determined that the heat transfer system disclosed herein provides a better metal strand product that is less prone to cracking and warping as the metal stand cools along the path of rolls 10. The cylindrical rolls 12 are typically constructed of stainless steel, but any other appropriate material may be used that can bear the weight and heat of the metal strands that they are required to come in contact with.

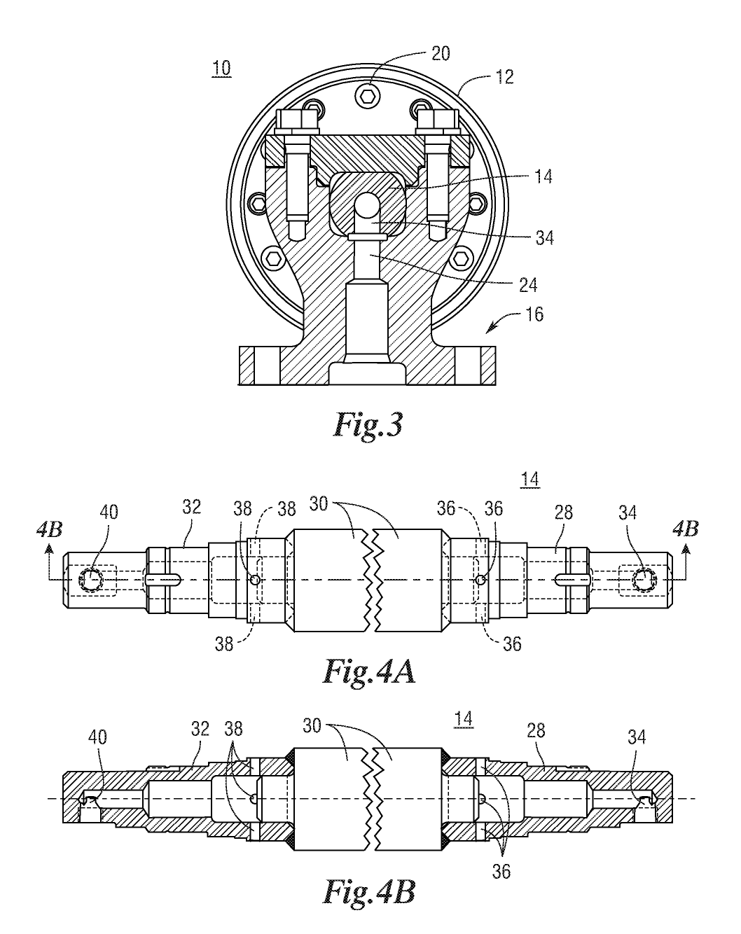

As best understood by comparing FIGS. 2-4B, the cylindrical roll 12 is mounted to the axle 14 and supported with sealed bearings 20. A cooling chamber 22 is formed between the cylindrical roll 12 and the axle 14 and surrounds the axle 14. The first roll support system 16 has a fluid pathway connected to a coolant supply system 24 and the second roll support 18 is has a fluid pathway connected to a coolant drain system 26. The axle 14 comprises three parts: a coolant inlet system 28, a barrel 30, and a coolant outlet system 32. The coolant inlet system 28 has a fluid pathway with a first inlet 34 connected to the fluid pathway in the first roll support 16 and a first outlet 36 connected to the coolant chamber 22. The coolant outlet system 32 has fluid pathway with a second inlet 38 connected to the coolant chamber 22, and a second outlet 40 connected to the fluid pathway of the second roll support 18. These fluid pathways are linked to create a coolant flow circuit that has a flow path from the coolant supply system 24 to the coolant drain system 26 through the first roll support 16, the first inlet 34 and the first outlet 36 of the coolant inlet system 28, the coolant chamber 22, the second inlet 38 and the second outlet 40 of the coolant outlet system 32, and the second roll support 18. In some applications, Teflon impregnated nylon sleeves 42 may be installed on the axle 14 between the cylindrical roll 12 and each of the first support system 16 and the second support system 18. These sleeves 42 provide erosion protection for the bearings 20.

The rolls 10 are of any size that is required for the particular application. The only difference between rolls 10 of different sizes is the length of the barrel 30 and the cylindrical roll 12. With longer barrels 30, the coolant chambers 22 of such longer rolls 10 are larger and have a higher capacity. All other components would be the same. Typically, horizontally oriented rolls 10 have cylindrical rolls 12 are that 9 inches up to 92 inches in length with a diameter of 5.5 inches up to 13 inches. Vertically oriented rolls 10 do not need to be as large and have cylindrical rolls 12 are typically 140 mm to 270 mm long and of varying diameters. The exact length and diameters of the particular cylindrical roll 12 depends on the particular application.

The coolant supply system is preferably supplied with water, but other coolant fluids may be used such as oil or other fluids. The water may also have other additives to assist with the cooling function. The coolant supply is preferably supplied under pressure with a pumping system. This allows the operation of a continuous flow of coolant through the roll 10 during operation. The coolant is preferably supplied at 30 psi through the coolant supply system, however any other pressure range may be used.

The figures show that the first outlet 36 leading into the coolant chamber 22 and the second inlet 38 leading out of the coolant chamber 22 each comprise a series of openings in the circumference of the axle 14. The number, shape, size and arrangement of these openings in the axle 14 can be varied according to the specific application. The first inlet 34 and the second outlet 40 are sized to fit into the fluid pathway in the first roll support 16 and the second roll support 18, respectively to create the fluid pathway for coolant through the roll 10.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A roll for continuous casting comprising:
a cylindrical roll rotatably mounted on a fixed axle and having a cooling chamber for receiving a flow of coolant, said coolant chamber surrounding said axle;
said axle mounted on a roll support system and comprising a coolant inlet system, a barrel, and a coolant outlet system;
said roll support system further comprises:
a first roll support connected to a coolant supply system; and
a second roll support connected to a coolant drain system;
said coolant inlet system comprises a first inlet connected to said first roll support and a first outlet connected to said coolant chamber;
said coolant outlet system comprises a second inlet connected to said coolant chamber; and a second outlet connected to said second roll support; and
a coolant flow circuit that has a flow path from said coolant supply system to said coolant drain system through said first roll support, said first inlet and said first outlet of said coolant inlet system, said coolant chamber, said second inlet and said second outlet of said coolant outlet system, and said second roll support.

2. The roll of claim 1 in which said coolant is water.

3. The roll of claim 1 in which said coolant is supplied from said coolant supply system at 30 psi.

4. The roll of claim 1 in which said cylindrical roll is supported on said axle with sealed bearings.

5. The roll of claim 1 in which said coolant supply system provides a continuous flow of coolant to said coolant flow circuit while said roll is in operation.

6. The roll of claim 1 further comprising sleeves interposed on said axle between said cylindrical roll and each of said first roll support and said second roll support.
